(19) United States
(12) Patent Application Publication
(10) Pub. No.: US 2025/0153249 A1
(43) Pub. Date: May 15, 2025

(54) TOOL HOLDER FOR EASY ASSEMBLY AND DISASSEMBLY

(71) Applicant: SHIN-YAIN INDUSTRIAL CO., LTD., Taichung City (TW)

(72) Inventor: Pen Hung CHEN, Taichung City (TW)

(73) Assignee: SHIN-YAIN INDUSTRIAL CO., LTD., Taichung City (TW)

(21) Appl. No.: 18/507,355

(22) Filed: Nov. 13, 2023

(51) Int. Cl. B23B 31/11

(52) U.S. Cl. CPC B23B 31/1107

(57) ABSTRACT

A tool holder has a holder body, a chuck, and a clamping nut. The chuck has an annular groove, a nut positioning portion, and a cutting surface. The cutting surface is formed on a periphery of the nut positioning portion by cutting. The clamping nut has a protruding edge. When assembling the chuck and the clamping nut, the cutting surface allows the protruding edge to easily avoid and pass by the nut positioning portion, enter the annular groove, and be engaged in the annular groove, which lowers difficulty of assembly. During disassembly, the protruding edge is configured to abut the nut positioning portion, which allows the chuck to be easily detached from the holder body together with the clamping nut when unscrewing the clamping nut from the holder body.

### BACKGROUND OF THE INVENTION

### 1. Field of the Invention

The present invention relates to a tool holder, and particularly to a tool holder for easy assembly and disassembly.

### 2. Description of Related Art

A tool holder is a component to mount a tool onto a spindle, and the tool holder has a chuck for fixing the tool, a holder body for being held on the spindle, and a clamping nut. The chuck (e.g. a collet chuck) has a construction configured to match with a construction inside the holder body such that when the clamping nut is screwed on the holder body, the chuck is tightened and fixed to the holder body.

For the convenience of disassembly of the chuck and the holder body when unscrewing the clamping nut, the clamping nut of a conventional tool holder has a protruding edge formed therein, and the chuck of the conventional tool holder has an annular recess for the protruding edge to be engaged therein. When the clamping nut is unscrewed from the holder body, the protruding edge engaged in the annular recess abuts against a position-limiting portion of the chuck being adjacent to the annular recess to allow the clamping nut to move and detach the chuck from the holder body as unscrewing, which is convenient for disassembly.

When assembling the conventional tool holder mentioned above, the chuck is first assembled with the clamping nut, and then the clamping nut is screwed on the holder body to tighten and fix the chuck to the holder body. To assemble the chuck with the clamping nut having the configuration of the protruding edge and the annular groove, the protruding edge forms an eccentric construction inside the clamping nut, and the chuck needs to be located through the clamping nut at a specific angle such that the position-limiting portion is able to pass by the protruding edge, allowing the protruding edge to be engaged in the annular recess; assembly of the chuck and the clamping nut is then finished. However, adjusting the chuck to the specific angle can be difficult in operation, and the chuck needs to be adjusted continuously during assembling, which is time consuming and not cost-effective.

To overcome the shortcomings of the conventional tool holder mentioned above, the present invention tends to provide a tool holder for easy assembly and disassembly to mitigate or obviate the aforementioned problems.

### SUMMARY OF THE INVENTION

The main objective of the present invention is to provide a tool holder for easy assembly and disassembly that lowers the difficulty of assembly and is still convenient for disassembly.

The tool holder for easy assembly and disassembly has a holder body, a chuck, and a clamping nut. The chuck has an annular groove, a nut positioning portion, and at least one cutting surface. The annular groove is recessed on a periphery of the chuck, and the nut positioning portion is disposed adjacent to the annular groove. The at least one cutting surface is formed on a periphery of the nut positioning portion by cutting and defines a distance between an axis of the nut positioning portion and said cutting surface being smaller than a radius of the nut positioning portion. The clamping nut is configured to be screwed on the holder body to tighten and fix the chuck to the holder body and has a protruding edge. The protruding edge is configured to pass by said cutting surface to enter the annular groove, be blocked by the nut positioning portion, and thereby be engaged in the annular groove.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tool holder for easy assembly and disassembly of a preferred embodiment in accordance with the present invention;
FIG. 2 is a three-quarter sectional view of the tool holder in FIG. 1;
FIG. 3 is an exploded view of the tool holder in FIG. 1;
FIG. 4 is an exploded view of a chuck and a clamping nut in three-quarter section of the tool holder in FIG. 1;

FIGS. 5 to 7 are operational views depicting assembly of the chuck and the clamping nut of the tool holder in FIG. 1;

FIG. 8 is a sectional side view of the tool holder in FIG. 1; and
FIG. 9 is a sectional view of the tool holder across line 9-9 in FIG. 8.

### DETAILED DESCRIPTION OF THE PREFERRED EMBODIMENT

With reference to FIGS. 1 to 3, a tool holder for easy assembly and disassembly of a preferred embodiment in accordance with the present invention has a holder body 10, a chuck 20, and a clamping nut 30. The tool holder is configured to be mounted to a spindle via the holder body 10. The chuck 20 is configured for mounting a tool thereto. The clamping nut 30 is configured to be screwed on the holder body 10 to tighten and fix the chuck 20 to the holder body 10 such that the tool mounted to the chuck 20 can be fixed on the spindle for processing.

With reference to FIGS. 2 and 3, the holder body 10 has a spindle end and a tool end being opposite to each other; the holder body 10 has a mounting hole disposed on the spindle end and configured for the holder body 10 to be fixed on the spindle, and the holder body 10 has a conical hole 11 and an external thread 12. The conical hole 11 is formed inside the holder body 10 and tapers from the tool end toward the spindle end. The external thread 12 is formed on a periphery of the tool end of the holder body 10 for the clamping nut 30 to be screwed on the holder body 10. With reference to FIGS. 2 to 4, the chuck 20 has a holder body positioning portion 21 and a nut positioning portion 22 respectively for assembly with the holder body 10 and the clamping nut 30. In the preferred embodiment, the holder body positioning portion 21 has a conical construction to match the conical hole 11.

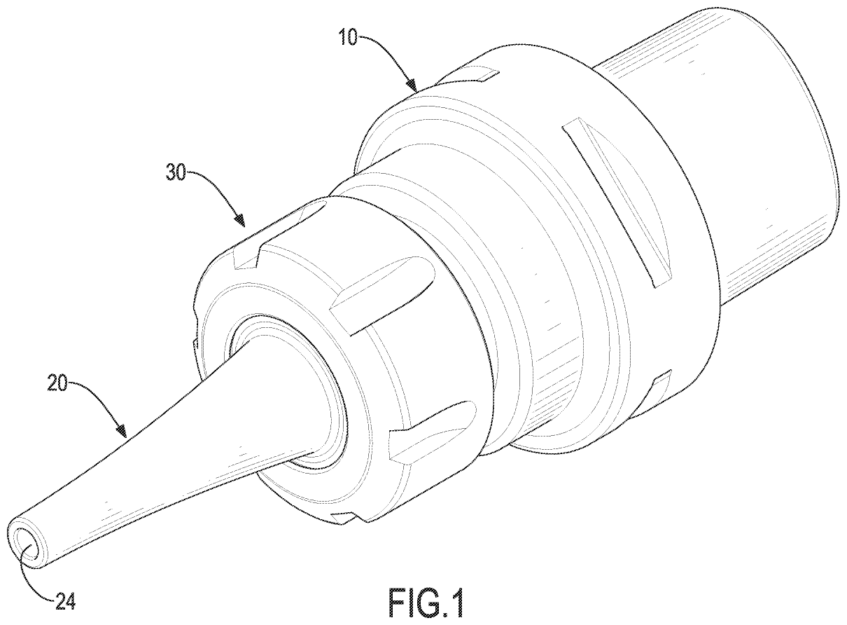

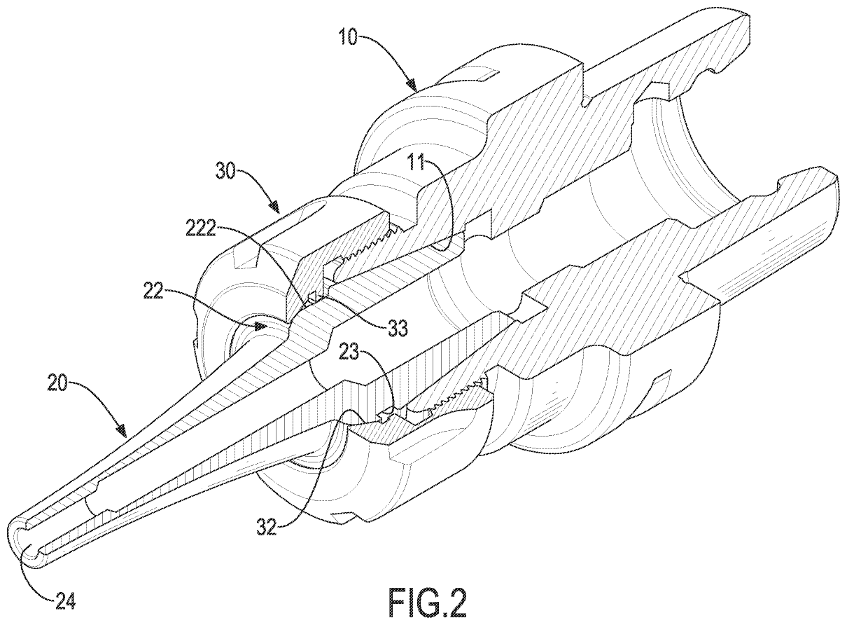

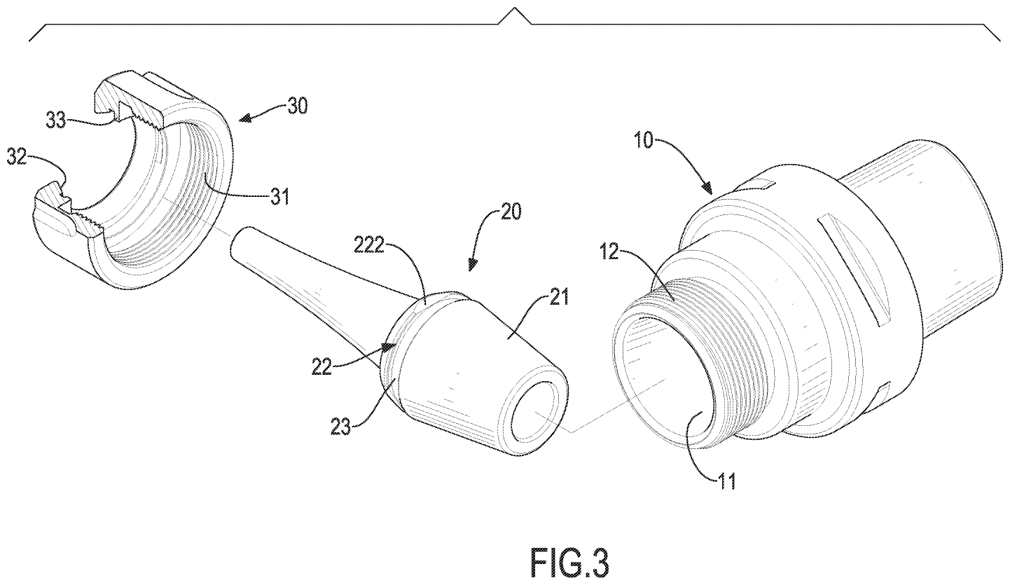

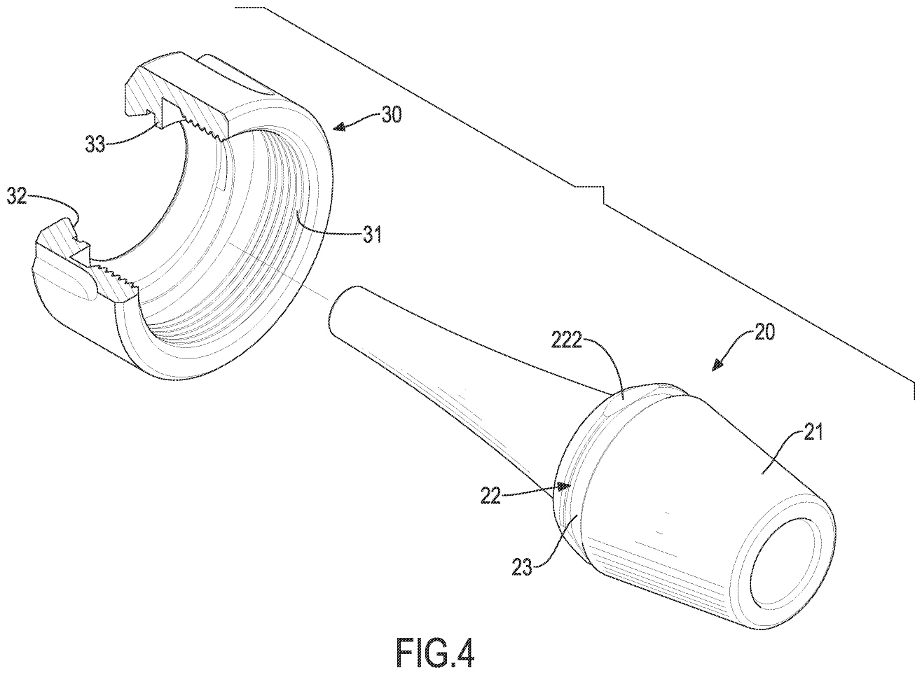

With reference to FIGS. 2 and 4, the clamping nut 30 has a first side and a second side being opposite to each other, an internal thread 31, and a protruding edge 33. The internal thread 31 is located near the first side of the clamping nut 30 and matches the external thread 12 of the holder body 10. The protruding edge 33 protrudes from an internal wall of the clamping nut 30 toward an axis of the clamping nut 30. Correspondingly, the chuck 20 has an annular groove 23 recessed on a periphery of the chuck 20, and the holder body positioning portion 21 and the nut positioning portion 22 are respectively connected to two opposite sides of the annular groove 23.

With reference to FIGS. 2, 8, and 9, when the chuck 20 and the clamping nut 30 are assembled, the protruding edge 33 is blocked by the holder body positioning portion 21 and the nut positioning portion 22 and thereby engaged in the annular groove 23, which prevents the chuck 20 and the clamping nut 30 from being inadvertently detached from each other.

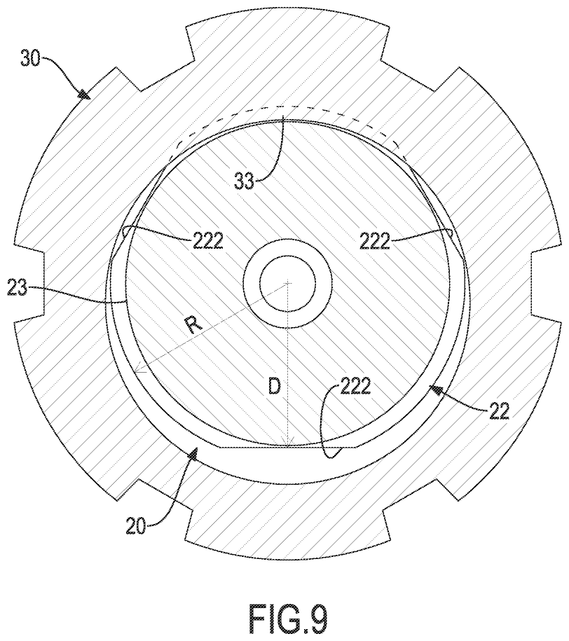

Additionally, with reference to FIG. 9, the protruding edge 33 forms an eccentric construction inside the clamping nut 30; i.e., a space surrounded by the clamping nut 30 has a section located corresponding to the position of the protruding edge 33 and having a central point located elsewhere than at the axis of the clamping nut 30.

With reference to FIGS. 3, 4, and 9, the chuck 20 has three cutting surfaces 222 formed on a periphery of the nut positioning portion 22 by cutting; i.e., during processing, material is removed from a periphery of a work in process (WIP) of the nut positioning portion 22 to form said cutting surfaces 222.

Thereby, with reference to FIG. 9, each one of the three cutting surfaces 222 defines a distance D between an axis of the nut positioning portion 22 and said cutting surface 222, wherein the distance D is smaller than a radius R of the nut positioning portion 22. With said cutting surfaces 222, assembly of the chuck 20 and the clamping nut 30 can be easier, which is described below with details of assembly of the chuck 20 and the clamping nut 30.

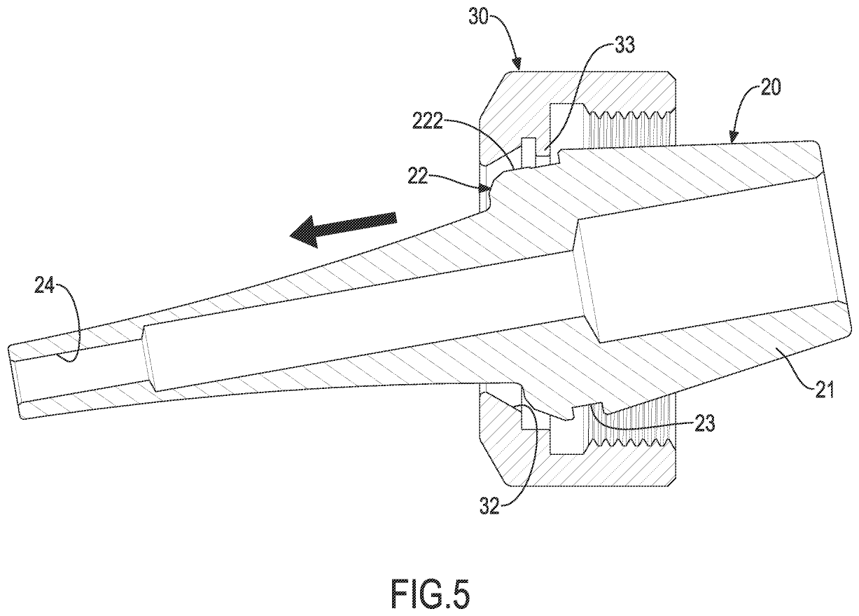

When assembling the tool holder of the present invention, the chuck 20 and the clamping nut 30 are assembled first. With reference to FIG. 5, the chuck 20 is inserted into the space surrounded by the clamping nut 30 from the first side of the clamping nut 30 near the internal thread 31 (i.e. the chuck 20 is inserted toward the left side of FIG. 5), and then the chuck 20 extends out from the second side of the clamping nut 30 such that the chuck 20 is located through the clamping nut 30. Since the protruding edge 33 protruding from an internal wall of the clamping nut 30 is configured to be engaged in the annular groove 23, the nut positioning portion 22 can easily abut the protruding edge 33 to obstruct the assembly when approaching the protruding edge 33; thereby, the chuck 20 is adjusted to a proper angle first to allow an axis of the chuck 20 (the nut positioning portion 22) to be inclined relative to the axis of the clamping nut 30 and allow the nut positioning portion 22 to face toward the protruding edge 33 (specifically the thickest portion of the protruding edge 33) with one of the three cutting surfaces 222, and the chuck 20 can be moved toward the left side of FIG. 5 afterward. The nut positioning portion 22 is able to avoid and pass by the protruding edge 33 via said cutting surface 222, and in other words, the protruding edge 33 passes by said cutting surface 222 as shown in FIG. 5.

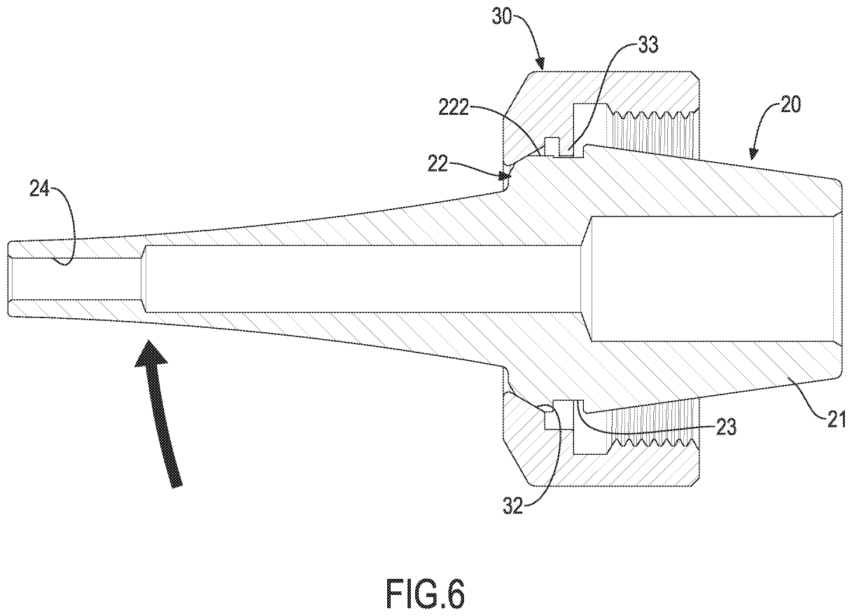

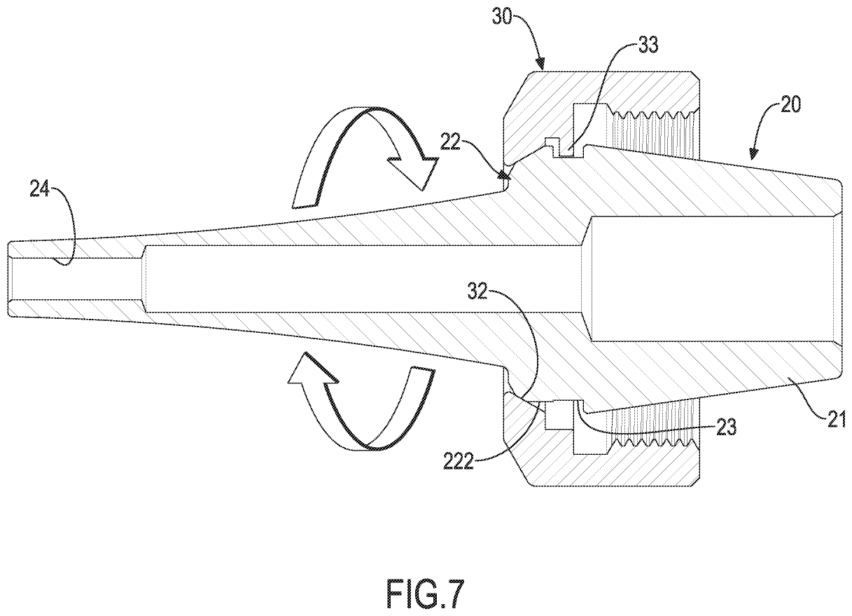

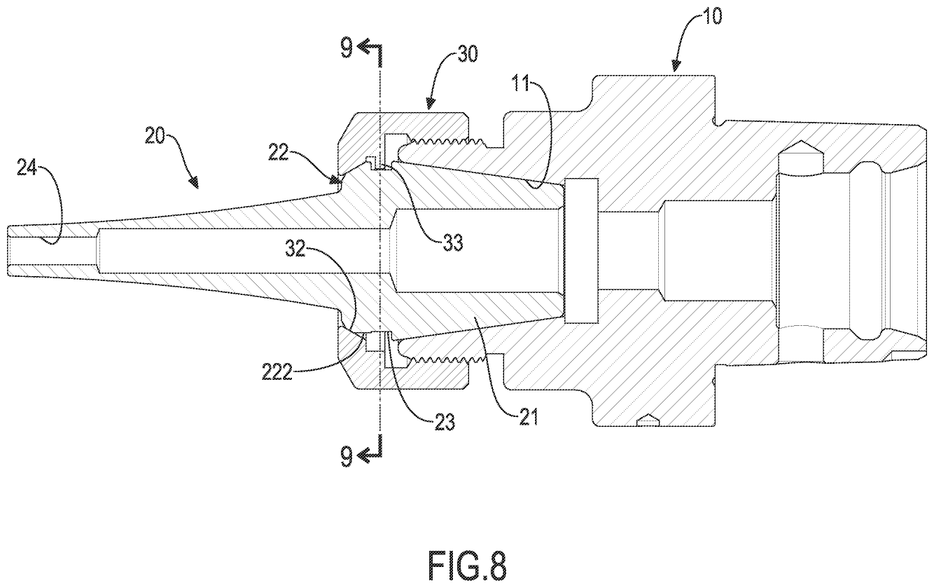

Afterward, since the protruding edge 33 passes by said cutting surface 222, the chuck 20 can be adjusted to an original angle to be coaxial with the clamping nut 30 as shown in FIG. 6, which ensures the protruding edge 33 will enter the annular groove 23. With reference to FIG. 7, then, the chuck 20 is then rotated to deflect said cutting surface 222 such that the nut positioning portion 22 faces toward the protruding edge 33 with a portion of its periphery elsewhere from said cutting surfaces 222. Hence, the protruding edge 33 is blocked by the nut positioning portion 22 and is thereby engaged in the annular groove 23 to prevent inadvertent detachment of the chuck 20 and the clamping nut 30. The assembly of the chuck 20 and the clamping nut 30 is then finished.

With reference to FIGS. 2 to 4, in the preferred embodiment, the clamping nut 30 has an interior conical surface 32; the internal thread 31 and the interior conical surface 32 are respectively located near the first side and the second side of the clamping nut 30, and the interior conical surface 32 tapers toward the second side. The nut positioning portion 22 has a conical construction to match the interior conical surface 32. When the protruding edge 33 is engaged in the annular groove 23, the nut positioning portion 22 having the conical construction can abut the interior conical surface 32. With the conical matching configuration, inadvertent detachment of the chuck 20 and the clamping nut 30 can be further prevented.

Last, with reference to FIG. 8, the clamping nut 30 is screwed on the holder body 10 via a hand tool (e.g. a screwdriver), and the chuck 20 assembled with the clamping nut 30 can be assembled with the holder body 10 together. Specifically, when the clamping nut 30 is sheathed on the tool end of the holder body 10, the holder body positioning portion 21 of the chuck 20 is inserted into the conical hole 11 of the holder body 10. As the internal thread 31 of the clamping nut 30 and the external thread 12 of the holder body 10 are gradually threaded with each other, the chuck 20 is actuated by the clamping nut 30 such that the holder body positioning portion 21 gradually reaches a depth of the conical hole 11. Finally, the holder body positioning portion 21 having the conical construction abuts an inner surface of the conical hole 11. The chuck 20 is thus tightened and fixed to the holder body 10.

With reference to FIG. 9, as described above, since the nut positioning portion 22 faces toward the protruding edge 33 with a portion of the periphery elsewhere from said cutting surfaces 222, the protruding edge 33 is blocked by the nut positioning portion 22 and engaged in the annular groove 23. Thereby, when unscrewing the clamping nut 30 from the holder body 10 during disassembly, the protruding edge 33 abuts against the nut positioning portion 22 such that the holder body positioning portion 21 of the chuck 20 gradually withdraws from the conical hole 11 of the holder body 10, which allows the chuck 20 to be detached from the holder body 10 together when unscrewing the clamping nut 30 from the holder body 10. With the above configurations, an operator can quickly detach the chuck 20 and the clamping nut 30 from the holder body 10, which improves convenience of disassembly of the tool holder.

In the conventional tool holder of the related art, since the protruding edge and the position-limiting portion easily abut each other and obstruct assembly of the clamping nut and the chuck, the angle of the chuck needs to be adjusted continuously during assembly to allow the position-limiting portion to avoid and pass by the protruding edge. In comparison, the tool holder for easy assembly and disassembly of the present invention has said cutting surfaces 222 formed on the nut positioning portion 22 by cutting. During assembly, the nut positioning portion 22 is able to face toward the protruding edge 33 with said cutting surface 222 such that the protruding edge 33 can pass by said cutting surface 222 to enter the annular groove 23. Not only the easy-to-disassemble configuration of the protruding edge 33 and the annular groove 23 can be retained, but difficulty of assembling the chuck 20 and the clamping nut 30 can be significantly reduced via said cutting surface 222; assembly of the chuck 20 and the clamping nut 30 is easier and more convenient.

In other embodiments, the chuck 20 may have only one said cutting surface 222 or multiple said cutting surfaces 222 formed on the nut positioning portion 22 by cutting, and the chuck 20 is still configured to avoid the protruding edge 33 with said cutting surface 222 to lower difficulty of assembling the chuck 20 and the clamping nut 30. In the preferred embodiment, the three cutting surfaces 222 allow the operator to finish adjustment of the chuck 20 as long as any one of the three cutting surfaces 222 faces toward the protruding edge 33; the three cutting surfaces 222 all allow the nut positioning portion 22 to avoid and pass by the protruding edge 33. Also, the three cutting surfaces 222 are arranged at equiangular intervals; i.e., adjacent two of the three cutting surfaces 222 have a distance therebetween, which not only improves convenience of operation but also prevents the protruding edge 33 from being easily detached from the annular groove 23 due to said cutting surfaces 222.

In the preferred embodiment, the holder body positioning portion 21 inserted into the conical hole 11 and the nut positioning portion 22 abutting the interior conical surface 32 are both conical matching constructions and allow the chuck to be tightened and fixed to the holder body 10 and the clamping nut 30 when the clamping nut 30 is screwed on the holder body 10; the assembly of the tool holder is thus stable. In other embodiments, the two configurations mentioned above may adopt other tightening constructions in other conventional tool holders, not limited to the preferred embodiment.

Additionally, in the preferred embodiment, the chuck 20 is a shrink-fit chuck; specifically, the chuck 20 has an interior clamping hole 24 extending along an axial direction of the chuck 20. Before mounting a tool to the chuck 20, the chuck 20 is heated first to allow the interior clamping hole 24 to expand (i.e. a temperature of the chuck 20 increases, and the diameter of the interior clamping hole 24 increases), which allows the tool to be inserted into the interior clamping hole 24. Afterward, the chuck 20 is cooled down to allow the interior clamping hole 24 to contract (i.e. the temperature of the chuck 20 decreases, and the diameter of the interior clamping hole 24 decreases) such that the tool installed into the interior clamping hole 24 is clamped by the chuck 20. By the abovementioned assembly of the chuck 20, the clamping nut 30, and the holder body 10, the tool mounted to the chuck 20 can be fixed onto a spindle of a machine for processing.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tool holder for easy assembly and disassembly, the tool holder comprising:
a holder body;
a chuck having
an annular groove recessed on a periphery of the chuck;
a nut positioning portion disposed adjacent to the annular groove; and
at least one cutting surface formed on a periphery of the nut positioning portion by cutting and defining a distance between an axis of the nut positioning portion and said cutting surface being smaller than a radius of the nut positioning portion; and
a clamping nut being screwable on the holder body to tighten and fix the chuck to the holder body and having
a protruding edge configured to pass said cutting surface, enter the annular groove, be blocked by the nut positioning portion, and thereby be engaged in the annular groove.

2. The tool holder as claimed in claim 1, wherein the chuck has multiple said cutting surfaces.

3. The tool holder as claimed in claim 2, wherein the multiple cutting surfaces are arranged at equiangular intervals.

4. The tool holder as claimed in claim 1, wherein
the clamping nut has an interior conical surface; and
the nut positioning portion has a conical construction allowing the nut positioning portion to abut the interior conical surface when the protruding edge is engaged in the annular groove.

5. The tool holder as claimed in claim 2, wherein
the clamping nut has an interior conical surface; and
the nut positioning portion has a conical construction allowing the nut positioning portion to abut the interior conical surface when the protruding edge is engaged in the annular groove.

6. The tool holder as claimed in claim 3, wherein
the clamping nut has an interior conical surface; and
the nut positioning portion has a conical construction allowing the nut positioning portion to abut the interior conical surface when the protruding edge is engaged in the annular groove.

7. The tool holder as claimed in claim 1, wherein
the holder body has a conical hole; and
the chuck has a holder body positioning portion having a conical construction to match the conical hole and abut an inner surface of the conical hole.

8. The tool holder as claimed in claim 2, wherein
the holder body has a conical hole; and
the chuck has a holder body positioning portion having a conical construction to match the conical hole and abut an inner surface of the conical hole.

9. The tool holder as claimed in claim 3, wherein
the holder body has a conical hole; and
the chuck has a holder body positioning portion having a conical construction to match the conical hole and abut an inner surface of the conical hole.

10. The tool holder as claimed in claim 1, wherein the chuck is a shrink-fit chuck and has an interior clamping hole configured to expand or contract as a temperature of the chuck changes for a tool to be installed or clamped therein.

11. The tool holder as claimed in claim 2, wherein the chuck is a shrink-fit chuck and has an interior clamping hole configured to expand or contract as a temperature of the chuck changes for a tool to be installed or clamped therein.

12. The tool holder as claimed in claim 3, wherein the chuck is a shrink-fit chuck and has an interior clamping hole configured to expand or contract as a temperature of the chuck changes for a tool to be installed or clamped therein.
